(19) United States
(12) Patent Application Publication
(10) Pub. No.: US 2018/0025305 A1
(43) Pub. Date: Jan. 25, 2018

(54) Calendar Based Economic Engine

(71) Applicant: Sean Edward Rutherford, Beaverton, OR (US)

(72) Inventor: Sean Edward Rutherford, Beaverton, OR (US)

(21) Appl. No.: 15/216,611

(22) Filed: Jul. 21, 2016

(51) Int. Cl. G06Q 10/06

(52) U.S. Cl. CPC G06Q 10/06314

(57) ABSTRACT

A calendar based economic engine is disclosed comprising month owned days (Hypatian days), week days, months and years. When Hypatian days are inserted into months an enhanced economic flow similar to that found in holidays is created. The regular month to month occurrence of Hypatian periods also produces a localization of the economic effect.

### BACKGROUND OF THE INVENTION

Prolonged and unusual periods of non-work days go hand in hand with accelerated economic activity. This however is an accidental byproduct that has come to pass as holidays and other changes to the calendar system have been adopted over time. Months as well as years have variances as to what parts are work and non-work days, as well as which of these work/non-work days months and years start and end on. This system carries a byproduct of added economic instability. The calendar system was not designed to incorporate it's effect on economic structures.

Thus, it is advantageous to provide a calendar system that facilitates it's use as an economic engine.

### CROSS REFERENCE TO RELATED APPLICATIONS

None

### FIELD OF THE INVENTION

The Present invention relates to methods of creating an economic engine by setting which days of the weeks, months and years are standard work days, commonly referred to as week days, and which days are standard non-work days, commonly referred to as weekend days.

### SUMMARY OF THE INVENTION

The present invention provides a calendar based economic engine comprising days belonging to the months they are in (Hypatian days), week days, months, and years.

Is an aspect of an embodiment of the present invention to provide sufficient Hypatian days in each month to set subsequent months to begin on the same week day as their predecessors.

The invention claimed is:

1. A calendar system based economic engine that uses sequences of work and non-work days to effect the flow, type and level of economic activity. Of the days there are two types. Day type 1, referred to hereafter as Hypatian days, are days which are inserted into months. Hypatian days belong to the months in which they are placed rather than being part of a week. These Hypatian days are designated as non-work type days though work type Hypatian days are envisioned as well. The placement of non work Hypatian days in months creates month based non-work periods (Hypatian period). The Hypatian days are placed in the last two to three days in a given month depending on the length of the month. Other placements of Hypatian days are envisioned as well. This placement of Hypatian days produces increased economic activity during the Hypatian period; an economic effect similar to that found during holidays. This also produces enhanced leisure related type and level economic activity during these periods. Their regular occurrence and length create a localization of economic activity effect. The other type of days, day type 2, are week days. Week days belong to the weeks in which they are placed. The current structure of weeks is 5 standard work days and 2 are standard non-work days totaling a 7 day week. Week structures with other numbers of days as well as other numbers of standard work and standard non-work days within a week are envisioned as well. Weeks with varying numbers of days per week in the same calendar year and even in the same month are also envisioned.

2. The economic engine of claim 1 further comprising the use of Hypatian days to fill out the month such that each consecutive month starts out on the same day of the week as the preceding month. This normalizes economic and activity projections month to month providing extended stabilization of the economic substructures.
